(19) United States
(12) Patent Application Publication
(10) Pub. No.: US 2006/0267325 A1
(43) Pub. Date: Nov. 30, 2006

(54) Passenger protecting system

(75) Inventors: Masayoshi Kumagai, Tokyo (JP); Yasuo Itoga, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/439,135

(22) Filed: May 24, 2006

Related U.S. Application Data
(60) Provisional application No. 60/684,231, filed on May 25, 2005.

(51) Int. Cl. B60N 2/42; B60R 21/207; B60R 21/04

(52) U.S. Cl. 280/753; 280/730.1; 297/216.1

(57) ABSTRACT

A passenger protecting apparatus includes a seat including a seat cushion and a seat back. The apparatus also includes an airbag positioned under a seating surface of the seat cushion; an inflator for producing inflation gas to inflate the airbag. The inflator may be located within the airbag.

### BACKGROUND

This application claims priority to and the benefit of U.S. Provisional Patent Application No. 60/684,231 filed on May 25, 2005. The foregoing application is incorporated by reference herein in its entirety.

An apparatus for raising the front portion of the seat cushion upon collision of the vehicle in order to prevent a submarine phenomenon where the passenger is squeezed out through the lap belt downwardly in case of a frontal crash even when the passenger is wearing the seat belt has been provided. For example, in Japanese Unexamined Patent Application Publication No. 10-309967, a vehicle seat in which the front end of the seat cushion is adapted to be raised by a cartridge actuator is disclosed, and in Japanese Unexamined Patent Application Publication No. 10-217818, a vehicle seat in which the front end of the seat cushion is raised by an air bag is disclosed. Both of the aforementioned published patent applications are incorporated by reference herein.

### SUMMARY

A passenger protecting system including an airbag that may be contained in a seat cushion for protecting an occupant of a vehicle is disclosed herein. The system may be configured for either a front seat or a rear seat of a vehicle.

According to an embodiment of a passenger protecting system, the system may be controlled so that characteristics of the airbag may be regulated. For example, the airbag inflation may be controlled by the following exemplary mechanisms: inflator configuration and design; airbag configuration, including chamber size, location and number; airbag vent hole number and location; fluid connection arrangement between airbag chambers; fluid connection arrangement between airbag and airbag chambers and the inflator; providing a pressure control mechanism or device for controlling inflation gas, etc.

Further by way of example, the inner pressure and/or time for deployment may be regulated. To accomplish this, an inflator that provides gas to inflate the airbag may be controlled so that the inflator has various levels of output of gas.

In another exemplary embodiment, the output of the inflator may be controlled in accordance with information that is obtained by a vehicle sensor. For example, the system may include a controller that receives information from a sensor and determines the seriousness and pattern of a collision. The sensor may be configured to sense various vehicle characteristics such as, for example, acceleration, structurally integrity, pressure, velocity, etc. Alternatively, a sensor may be employed to sense occupant characteristics such as, for example, physique, weight, position, seatbelt operation or condition, or other similar information.

As mentioned above, the system may include a controller for controlling airbag deployment based on information received from a sensor. For example, the inflator may be controlled so that the Time to Fire (TTF) of the inflator is controlled and the output of the inflator is controlled so that the inner pressure of the airbag is regulated. The inner pressure of the airbag may be regulated for the entire airbag or for individual chambers of the airbag.

According to an exemplary embodiment, the airbag may be divided into one or more chambers that are inflated by gas output by the inflator. Gas supplied by the inflator flows into the one or more chambers to inflate the airbag.

In another embodiment, an inflator may be mounted in one of the chambers of the airbag. One or more communication holes may be provided between a chamber where the inflator is mounted and other chambers where the inflator is not mounted so that gas supplied by the inflator may flow between the chambers. For example, a dual inflator may be installed so that the dual inflator penetrates through one or more chambers of the airbag.

In an embodiment of the present invention, an inflator may have a inflation path that is divided into two or more branches or paths.

In an embodiment of the present invention, the airbag may be provided with one or more vent holes to control a level of Energy Absorption (EA).

The passenger (including any vehicle passenger including the driver of the vehicle) protecting system may be arranged to control the deployment of the airbag, depending upon the conditions of the collision and/or occupant, in order to reduce and/or prevent injury to an occupant more efficiently.

U.S. Pat. No. 6,715,788 illustrates various arrangements of airbags and airbags systems included in a vehicle seat. U.S. Pat. No. 6,715,788 is hereby incorporated by reference herein in its entirety. The airbag and passenger protecting system disclosed herein my be incorporated within the system and arrangement disclosed in U.S. Pat. No. 6,715,788.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a sectional view of a seat that includes an embodiment of a passenger protecting system.

FIG. 2a is a sectional top view of an airbag and inflator arrangement for a passenger protecting system.

FIGS. 2b-2d are side sectional views of embodiments of a passenger protecting system positioned adjacent a seat pan of a vehicle seat.

FIG. 3a is a sectional top view of an airbag and inflator arrangement for a passenger protecting system.

FIG. 3b is a side sectional view of an embodiment of a passenger protecting system positioned adjacent a seat pan of a vehicle seat.

FIGS. 4 and 5 are sectional top views of an airbag and inflator arrangements for a passenger protecting system.

FIG. 6a is a sectional top view of an airbag and inflator arrangement for a passenger protecting system.

FIGS. 6b-6d are side sectional views of embodiments of a passenger protecting system positioned adjacent a seat pan of a vehicle seat.

FIG. 7a is a sectional top view of an airbag and inflator arrangement for a passenger protecting system.

FIG. 7b is a side sectional view of an embodiment of a passenger protecting system positioned adjacent a seat pan of a vehicle seat.

FIGS. 8a and 8b are sectional top views of an airbag and inflator arrangement for a passenger protecting system.

FIG. 9a is a sectional top view of an airbag and inflator arrangement for a passenger protecting system.

FIG. 9b is a side sectional view of an embodiment of a passenger protecting system positioned adjacent a seat pan of a vehicle seat.

FIGS. 9c and 9d are sectional top views of an airbag and inflator arrangement for a passenger protecting system.

### DESCRIPTION

Embodiments of the disclosed system will be described with reference to the drawings. Like numbers are used throughout the drawings to refer to the same or similar parts in each of the embodiments described herein.

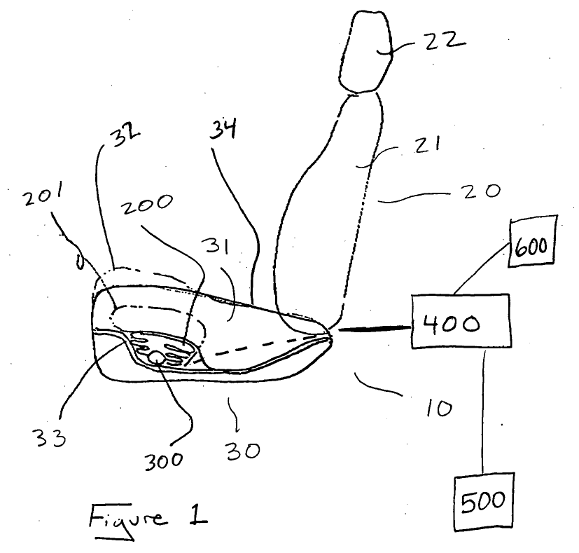

As shown in FIG. 1, a passenger safety system may include a vehicle seat 10. The seat may include a seat back 20 including, for example, a seat back rest 21 and a head rest 22. The seat 10 may also include a seat bottom 30. The seat bottom may include a seat pan 33 for supporting a seat cushion 31.

Various additional components may be positioned in the seat. For example, the seat may include an airbag 200 and an inflator 300. The airbag is configured to inflate below a seating surface 34 of the seat cushion 31 so that the seat cushion is moved upwardly to oppose forward movement of an occupant of the seat. An adjusted position of the seat cushion 32 is shown in FIG. 1. The airbag 200 is shown in its folded, pre-deployed state by solid lines while dashed lines are used to illustrate the airbag 201 in a deployed, post-crash state.

Also, the system may include a controller 400 configured to control the inflator 300 and deployment of the airbag 200. For example, the system may include a controller 400 that receives information from a sensor 500 and determines the seriousness and pattern of a collision. The sensor 500 may be configured to sense various vehicle characteristics such as, for example, acceleration, structurally integrity, pressure, velocity, etc. Alternatively, a sensor 600 may be employed to sense occupant characteristics such as, for example, physique, weight, position, seatbelt operation or condition, or other similar information.

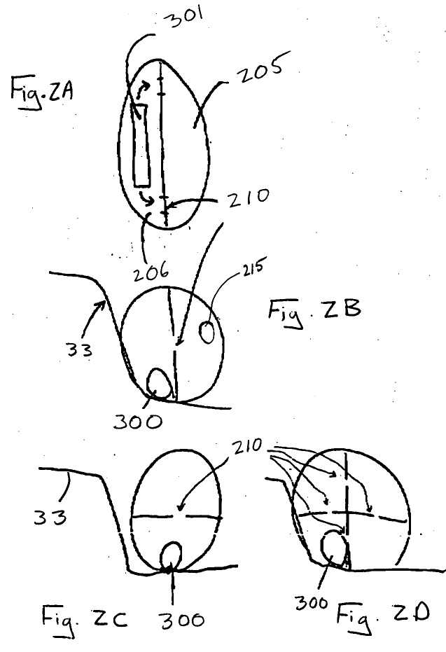

As shown in FIG. 2, the inflator 300 may be installed in the airbag 200 so that the inflator 300 is internal to the airbag 200 or embedded within the airbag 200. The inflator 300 may be a dual inflator that supplies inflation gas from each distal end of the inflator, as shown in the example of FIG. 2. The “dual” nature of the inflator may be provided by a single inflator with a plurality of exhaust ports, or may be provided by an integral pair of inflators separately actuated by separate initiators, for example.

As shown in FIG. 2a, the airbag 200 may be divided into a first chamber 205 and a second chamber 206. Also, as described further below, the airbag 200 may have further chambers. When the airbag 200 includes two or more chambers, one or more communication holes or openings 210 may be placed between the chambers, as shown in FIG. 2d, for example. The communication holes 210 may be used to provide paths for inflation gas to flow from an inflator 300 to chambers where the inflator is not installed. As shown in the different views of FIG. 2, different configurations of chambers, chamber divisions, and communication holes may be employed.

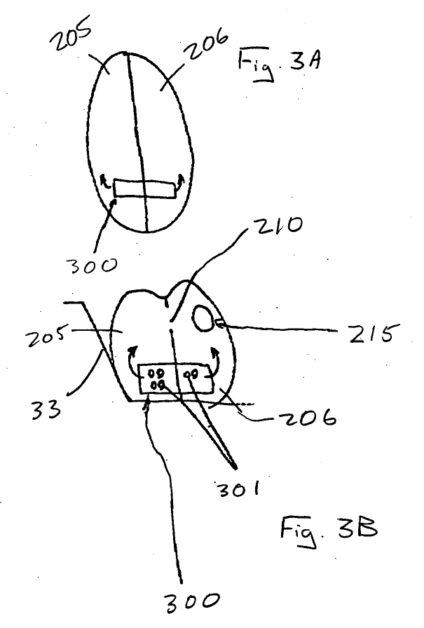

As shown in FIG. 3a, the inflator may extend between airbag chambers 205, 206. The dual inflator 300 may be installed internal to the airbag so that the inflator spans two inflation chambers. In such a configuration, the inflator may provide inflation gas from each distal end of the inflator so that each chamber 205, 206 is provided with inflation gas. As shown in FIG. 3b, communication holes 210 may be provided between chambers of the airbag. Communication holes 210 may be used to assist in the flow of inflation gas to the chambers of the airbag, particularly when the output from one side of the inflator is not necessarily equivalent to the output from the other side of the inflator, either by design or in practice. However, the airbag 200 may also be configured not to include openings or holes 210 between chambers of the airbag.

As shown in FIG. 3b, the inflator 300 may include orifices 301 for directing inflation gas out of the inflator. The inflator orifices or openings 301 may be distributed between the chambers of the inflator in order to provide for a tailored distribution of inflation gas. One possible distribution could be achieved by providing the same number of orifices 301 to each chamber. Of course, the volume of each airbag chamber may differ, which could change the desired distribution of the orifices 301.

As shown in FIG. 3b, the airbag 200 may also include vent holes 215. The vent holes may be provided to control a level of Energy Absorption (EA) from the occupant contacting the airbag 200. The vent holes 215 may be provided in either the longitudinal direction or lateral direction of the airbag.

As shown in FIG. 4, the passenger protecting system may include an arrange wherein airbag chambers are fluidly connected via a pipe 220. An elongated dual type inflator 300 spans two chambers 205, 207. A third chamber 206 is connected to one of the two chambers 207 via an external pipe 220. Furthermore, any one of the chambers may include a vent hole 215. FIG. 5 discloses an alternative embodiment wherein the airbag 200 includes two chambers 205, 206. As shown in FIGS. 4 and 5, the sizes of the airbag chambers may vary.

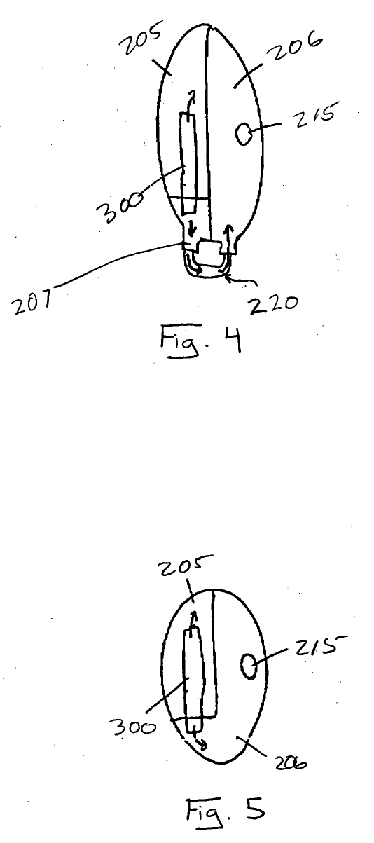

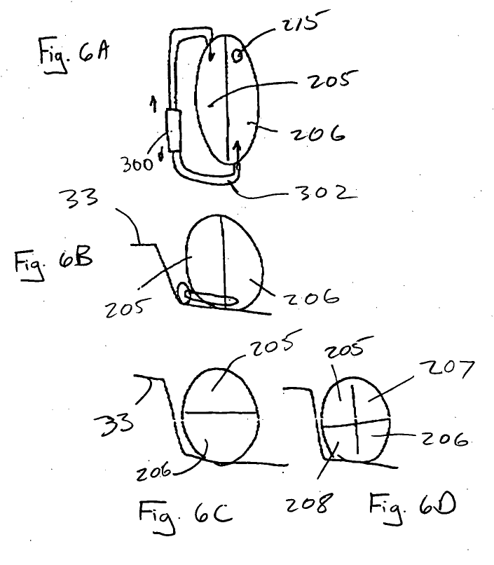

FIG. 6a discloses an alternative embodiment in which the inflator 300 is located outside of the airbag 200. For example, an inflator 300 may be installed external to the airbag 200, with the inflator 300 connected to the airbag by a pipe or conduit 302. Pipes, tubes, sewn pathways, and other gas supply mechanisms known in the art may be used to provide inflation gas conduits 302. As shown in FIGS. 6c and 6d the external inflator 300 may be provided with various airbag chamber arrangements.

In FIG. 6a, a dual inflator 300 may be installed external to an airbag 200 and provided with inflation gas conduits 302 to the distal ends of the airbag 200. The inflation gas conduits may be arranged to supply inflation gas to an airbag with one or more chambers, such as shown in FIGS. 6c and 6d. The inflation gas conduits may be arranged to supply inflation gas to the same chambers or different chambers of the airbag. For example, the inflation gas conduits may be arranged so that one inflation gas conduit supplies inflation gas to a first chamber while the other inflation gas conduit supplies inflation gas to a second chamber.

As shown in FIG. 7, one of the inflation gas conduits 302 at a distal end of the inflator may divide into branches 303 so that the inflation gas conduits provide inflation gas to a second chamber 206 and a third chamber 207 while a separate inflation gas conduit at the other distal end of the inflator provides inflation gas to a first chamber 205. Branching inflation gas conduits may be provided to supply inflation gas to separate chambers of an airbag, to supply inflation gas to the same chamber, or to supply inflation gas to the same chamber of an airbag and a separate chamber of the airbag. As shown in FIG. 7b, an internal inflator 300 may also be fluidly connected to an internal conduit 304 which is divided into braches 305.

In the embodiment shown in FIG. 7a, vent holes 215 may be provided to control a level of Energy Absorption (EA). The vent holes may be provided in either the longitudinal direction or lateral direction of the airbag. Vent holes 215 may be provided in any of the disclosed airbag embodiments.

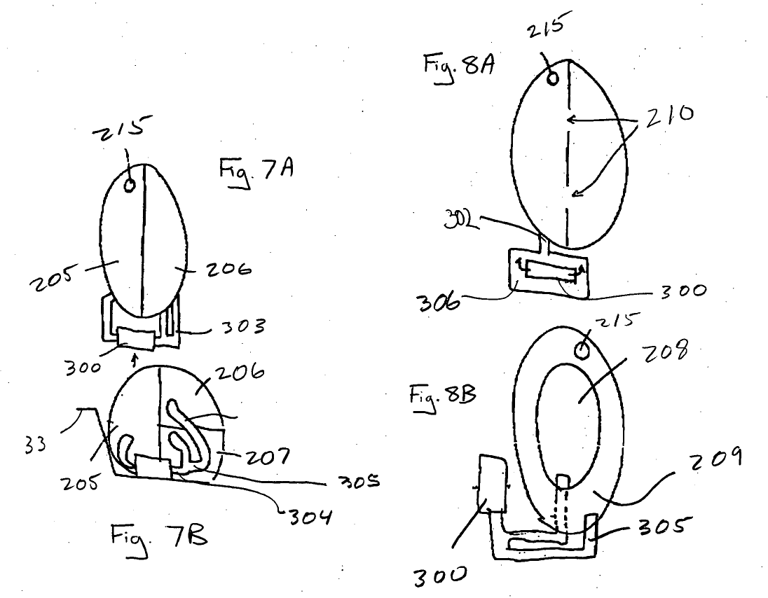

FIGS. 8a and 8b disclose further embodiments of a passenger safety system. For example, as shown in FIG. 8a, the inflator may be positioned in a gas chamber 306 configured to receive inflation gas from the inflator. Gas from the chamber 306 may be carried to the airbag 200 through a single conduit or a plurality of conduits. As shown in FIG. 8b, the airbag may be separated into an internal chamber 208 and an external chamber 209. An external inflator 300 may provide inflation gas to the chambers 208, 209 via a single conduit or, as shown in FIG. 8b, via separate conduit branches 303. Also, the airbag chambers may include vent holes 215.

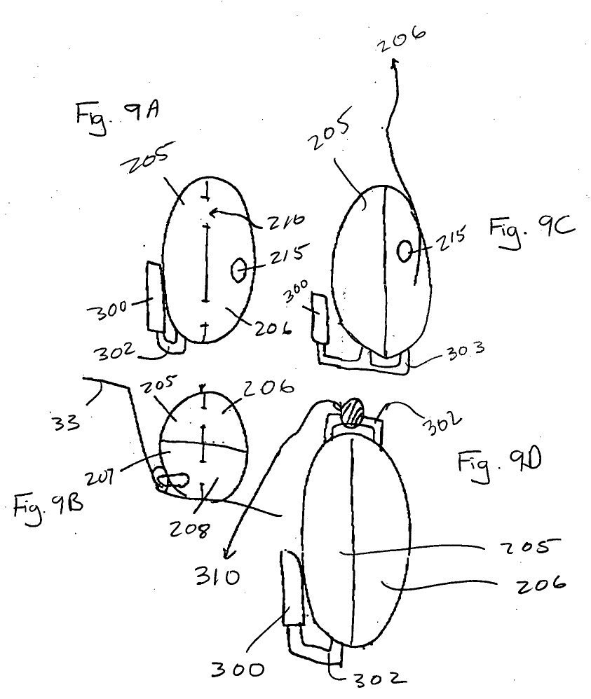

As shown in FIG. 9a, the inflator 300 may be located external to the airbag 200 and connected to the airbag via a conduit 302. The airbag may include four fluidly connected chambers, with one chamber directly connected to the conduit. Alternatively, as shown in FIG. 9c the inflator may be fluidly connected to two or more chambers by branches 303 of the conduit 302.

In any of the aforementioned embodiments, the airbag may include a pressure control device to provide more efficient control of the internal pressure of the airbag. For example, as shown in FIG. 9d, a pressure control valve or a check valve 310 may be provided. The valve may be provided on the inflation gas conduit 302 that leads from the inflator 300, one of the branches of the inflation gas conduits, or on a inflation gas conduit that connects two or more chambers of the airbag.

Given the disclosure of the present invention, one versed in the art would appreciate that there may be other embodiments and modifications within the scope and spirit of the invention. Accordingly, all modifications attainable by one versed in the art from the present disclosure that are within the scope and spirit of the present invention are to be included as further embodiments of the present invention. The scope of the present invention is to be defined as set forth in the following claims.

What is claimed is:

1. A passenger protecting apparatus comprising:
a seat including a seat cushion and a seat back, and
an airbag positioned under a seating surface of the seat cushion;
an inflator for producing inflation gas to inflate the airbag; and
wherein the inflator is located within the airbag.

2. The apparatus of claim 1, wherein the inflator includes at least two exit ports, and emits gas from both ports.

3. The apparatus of claim 2, wherein the airbag includes two chambers.

4. The apparatus of claim 3, wherein the inflator is configured so that each exit port provides gas to one of the two chambers.

5. The apparatus of claim 4, wherein the inflator includes additional exit ports configured to emit gas into the airbag and wherein the inflator is configured so that the number of exit ports providing gas to each airbag chamber is not the same for each chamber.

6. The apparatus of claim 1, wherein the airbag includes a dividing member between the two chambers, and wherein the dividing member includes at least one opening providing a fluid connection between the two chambers.

7. The apparatus of claim 6, wherein the inflator is located completely within one of the two chambers.

8. The apparatus of claim 3, wherein at least one of the airbag chambers includes a vent.

9. The apparatus of claim 7, further comprising a pipe connecting the two chambers.

10. A passenger protecting apparatus comprising:
a seat including a seat cushion and a seat back, and
an airbag positioned under a seating surface of the seat cushion;
an inflator for producing inflation gas to inflate the airbag; and
wherein the inflator is located external to the airbag.

11. The apparatus of claim 10, wherein the airbag includes two chambers.

12. The apparatus of claim 11, further comprising a pipe for carrying gas from the inflator to the airbag.

13. The apparatus of claim 11, further comprising a pipe connecting the two chambers together.

14. The apparatus of claim 13, further comprising a valve controlling gas flow through the pipe.

15. A passenger protecting apparatus comprising:
a seat including a seat cushion and a seat back, and
an airbag including a plurality of chambers and positioned under a seating surface of the seat cushion;
an inflator for producing inflation gas to inflate the airbag;
a controller for controlling the initiation of the inflator; and
a sensor operatively connected to the controller, wherein the sensor is configured to sense a vehicle or occupant characteristic.

16. The apparatus of claim 15, wherein the airbag includes a dividing member between at least two of the chambers, and wherein the dividing member includes at least one opening providing a fluid connection between the two chambers.

17. The apparatus of claim 16, wherein the inflator is located completely within one of the two chambers.

18. The apparatus of claim 15, wherein at least one of the airbag chambers includes a vent.

19. The apparatus of claim 15, wherein the airbag includes two chambers.

20. The apparatus of claim 19, further comprising a pipe for carrying gas from the inflator to the airbag.

21. The apparatus of claim 15, wherein the inflator is located external to the airbag.

22. The apparatus of claim 21, further comprising a valve controlling gas flow through the pipe.
